(19) United States
(12) Patent Application Publication
(10) Pub. No.: US 2014/0278639 A1
(43) Pub. Date: Sep. 18, 2014

(54) SYSTEM AND METHOD FOR INTERFACE MANAGEMENT

(71) Applicant: Coreworx Inc., Kitchener (CA)

(72) Inventors: Sandra Lynne MacGillivray, Baden (CA); Richard Edward Moroz, Kitchener (CA); Leslie Alexander Gap, Kitchener (CA); Kelly Ann Maloney, Kitchener (CA)

(21) Appl. No.: 13/834,978

(22) Filed: Mar. 15, 2013

(51) Int. Cl. G06Q 10/06

(52) U.S. Cl. CPC G06Q 10/06311
USPC 705/7.15

(57) ABSTRACT

A system, method and computer program product provide or enable collaborative interface management including schedule integration, such as from a work schedule maintained by a scheduling application for a project. Interface information is maintained in a database for a plurality of interfaces associated with the project where each interface has a need date of completion. Work schedule information is received for storing to the database, such as by importing and possibly mapping. The work schedule information includes respective work activities each activity having a finish date and an interface identifier for associating the work activity with a particular interface. The work schedule information is stored in association with the interface information in response to the interface identifier. The stored information is analyzed to determine schedule discrepancies. A user interface is provided to define the interface information and collaboratively manage the processing of the interface information by contractors and project owners.

### FIELD

The present matter relates generally to project management such as for capital projects and more particularly to a system and method for interface management between two or more parties of a project team.

### BACKGROUND

Construction projects are becoming more complex and larger in scale due in part to advances in technology and operations. These projects require many stakeholders, with different geographical locations and working cultures, collaborating with one another throughout a project life cycle. Effectively planning, designing, constructing, operating and maintaining these projects can require strong management and a sound technological foundation.

Interface management is identified as a key risk factor for major capital projects. A significant contributing factor is the number of interface dependencies that occur between multiple work packages, and the ability of a project team to manage and control these interfaces.

### SUMMARY

A system, method and computer program product provide or enable collaborative interface management including schedule integration, such as from a work schedule maintained by a scheduling application for a project. Interface information is maintained in a database for a plurality of interfaces associated with the project where each interface has a need date of completion. Work schedule information is received for storing to the database, such as by importing and possibly mapping. The work schedule information includes respective work activities each activity having a finish date and an interface identifier for associating the work activity with a particular interface. The work schedule information is stored in association with the interface information in response to the interface identifier. The stored information is analyzed to determine schedule discrepancies. A user interface is provided to define the interface information and collaboratively manage the processing of the interface information by contractors and project owners.

There is provided a computer implemented method of collaborative interface management comprising: maintaining interface information in a database for a plurality of interfaces associated with a project, each interface having a need date of completion; receiving at a processing unit work schedule information comprising respective work activities each activity having a planned finish date and an interface identifier for associating the work activity with a particular interface; storing in the database by the processing unit the work schedule information in association with the interface information; and analyzing by the processing unit the work schedule information and interface information to determine schedule discrepancies.

The method may comprise providing by the processing unit a user interface for defining the interface information, the interface responsive to workflow for collaboratively managing the processing of the interface information by a plurality of users and receiving by the processing unit input to process the interface information, the input generated in response to at least one schedule discrepancy. The plurality of users may be one or more contractor interface managers and one or more owner/operator interface managers having responsibilities to collaboratively manage the completion of the project. The method may further comprise providing by the processing unit an interface for importing the work schedule information, the work schedule information comprising output from a scheduling application. The method of may comprise mapping by the processing unit the work schedule information in accordance with a data definition for storing the work schedule information. The interface identifier may be one defined by inputting the interface identifier into the scheduling application to link a work schedule activity with an interface. The interface identifier may be one that is input into a user defined field provided by the scheduling application.

Some of the interface information for a particular interface defines an interface point related to one or more work packages awarded to respective contractors for completion in a construction project and wherein the interface identifier is used to associate at least one activity of the work schedule to a particular interface point.

Some of the interface information for a particular interface defines an interface agreement for at least one contractor to perform work to complete the particular interface in a construction project and wherein the interface identifier is used to associate at least one activity of the work schedule to a particular interface agreement.

The method may comprise comparing by the processing unit the respective need date and planned finish date to determine the schedule discrepancies. The comparing may be responsive to a user defined tolerance.

The work schedule information comprises data identifying at least some of the activities as critical, the method may further comprise identifying interfaces associated the critical activities as critical.

There is provided a system for collaborative interface management comprising a processing unit and a database. The processing unit is configured to maintain interface information in the database for a plurality of interfaces associated with a project, each interface having a need date of completion; receive work schedule information comprising respective work activities each activity having a planned finish date and an interface identifier for associating the work activity with a particular interface; store in the database the work schedule information in association with the interface information; and analyze the work schedule information and interface information to determine schedule discrepancies.

There is provided a computer program product comprising a non-transitory medium storing instructions and data for configuring the execution of a processing unit to provide collaborative interface management, the processing unit configured to: maintain interface information in the database for a plurality of interfaces associated with a project, each interface having a need date of completion; receive work schedule information comprising respective work activities each activity having a planned finish date and an interface identifier for associating the work activity with a particular interface; store in the database the work schedule information in association with the interface information; and analyze the work schedule information and interface information to determine schedule discrepancies.

### BRIEF DESCRIPTION OF THE DRAWINGS

The present matter may be further understood by reference to following description in conjunction with the appended drawings in which:

FIG. 1 is a block diagram representing an interface point relationship model;

FIG. 2 is an illustration of an interface management solution architecture in accordance with an example

FIG. 3 is an example work schedule for importing in an example format;

FIG. 4 is an mapping description excerpt in an example format;

FIG. 5 is a data description file in an example format;

FIG. 6 is a screen shot of a user interface for importing a work schedule in association with a work package in accordance with an example;

FIG. 7 is an example object model of a database for schedule integration;

FIG. 8 is a screen shot of an example Import Register; and,

FIG. 9 is an example of a work schedule discrepancy report.

In the following description like numerals refer to like structures and process in the diagrams.

### DETAILED DESCRIPTION

Within this document, the following terms are understood to have the meanings provided:
EPCM Engineering, Procurement and Construction Management
Interface Agreement (IA) Interface agreements are used by contractors to request information and deliverables from other parties and provide the detail for all agreements made regarding an interface.
Interface Management A collective project management term used for capital projects to denote a management program for intersecting or dependent scopes of work or interface points.
Interface Manager (IM) The Interface Manager is responsible for the interface process, communication, and coordination and reporting. This individual is responsible for managing, identifying and resolving internal and external interfaces with respective client and contractor teams. Each EPC participating on the project should have an Interface Manager assigned who acts as a single point of contact for interface related issues and queries related to the EPCs work package(s)
Interface Point (IP) The point in which two or more contracting parties or independent systems meet or communicate with each other (e.g. a tie-in point).
Owner/Operator The organization funding and ultimately operating the asset related to the project being executed (i.e., Offshore Oil & Gas Platform)
PMC Project management consultant
Requesting Party The party requesting specific information or deliverables via an Interface Agreement and is tied to or related to a physical interface.
Responding Party The party responsible for providing the response to an Interface Agreement request
Technical Contact Individual working on the project who supports the Interface Manager role in providing technical content in response to Interface Agreement requests; very often this role is filled by discipline engineers
Work Package Defines work scope splits between contractors; subset of a project that represents the scope of work awarded through a contract to a single contractor

Interface points result from technical complexities, compressed design-build time cycles, as well as issues such as environmental and regulatory requirements. The interface management solution described herein may be used to facilitate the interfaces between parties regarding roles and responsibilities, required dates for providing interface information and identification of critical interfaces early in a project. The interface points may be between divisions of a single company or may exist between companies that have no connection other than through the performance of the work for respective work packages coordinated by the solution.

The interface management solution may take the form of a system, method or computer program product (e.g. software instructions stored to a non-transitory medium in a manner for instructing a processor). The interface management solution may assist to provide early identification of issues with potential for impact to cost or schedule and to provide standardization across projects. Visibility into the process allows each party to react to potential issues in a timely manner.

The interface management solution uses an interface point to document and track interfaces within a particular project. Interface points are commonly used to identify physical interfaces (i.e. Piping—Fire Water, Piping—LP Fuel Gas to Burn Pit, Civil—Road interface), but can also be used to track commercial or environmental interfaces. It is common practice to identify these interfaces during Front End Engineering and Design (FEED) and include them as part of the work package definition for a contract award.

Interface agreements are used by contractors to request information and deliverables from other parties. Interface agreements require the review and approval of a respective contractor's Interface Manager. Interface managers are the single point of contact for each contractor. The interface manager should have sufficient authority to represent and make binding decisions on behalf of their organization.

The interface management solution may assist to provide early identification of issues with potential for impact to cost or schedule and to provide standardization across projects. Visibility into the process allows each party to react to potential issues in a timely manner.

Work schedules are used by contractors participating on a project to manage the task and activities that need to be handled in order to successfully complete their scope of work as per the contract. The scope often includes completing one or more interface points requiring cooperation with another or other contractors.

### Structure of Interface Information

The Interface Management solution supports a structured approach to handling and managing the interfaces for large capital projects starting from the FEED stage and progressing to the Engineering Procurement and Construction (EPC) stage. FIG. 1 illustrates this process which starts with identifying the work packages and progresses to the identification and creation of Interface Points. Interface Points can be created at any point during the projects life cycle and optionally included in contract bid packages.

After contract award, contractors have the responsibility to manage interfaces using Interface Agreements in the Interface Management Solution to document the deliverables and information required by other contractors. Mutual agreement and acceptance are required by contracting parties before the Interface Agreement can be closed. The Interface Point is not closed until all activities related to the interface have been closed and agreed. Contractors are responsible for the successful close out of Interfaces which fall under their contract package. Action Items can be created throughout the process.

The major components of the solution architecture 200, outlined in FIG. 2, comprise; an application server 202, a database server 204, managed backup repository 206, a firewall 208, internal user computers 210, remote user computers 212 and external user computers 214. It is understood that the architecture 200 is simplified, for example, omitting various network infrastructure.

The application server 202 provides components of the interface management application 216 for the user computers (210 and 212) and interfaces with the database server 204 and the managed backup server 206. The database server 204 is where all databases used by the application are managed. In some configurations, the database may be an Oracles® 10 g database or SQL Server 2008™ database from Microsoft Corporation.

Internal user computers 210 represent users that access the solution from inside the firewall 208. External user computers 212 represent external users that work remotely and access the application server 202 through the firewall using a secure connection (e.g. via virtual private network).

Interface points and agreements may be defined and stored in the interface management solution. Interface agreements may be tracked via work processes of the interface management solution, and include alerts and notifications, for example, so that timely responses are received. In one example, an interface agreement may be defined by contractor A requesting a response from contractor B. The interface agreement may include data such as described below. Workflow of the interface management solution may direct activities to Interface Managers of the contractors and an Owner/Operator to facilitate completion of the interface agreement. For example, through user interfaces, a contractor IM may be enabled to define an interface agreement request. The request may be forwarded for a response to another contractor IM. The response may be prepared and routed for review and acceptance to close the contract. The work process may include steps to permit an Owner/Operator to broker the agreement, for example endorsing the request and/or response. Work flow may permit the IMs the ability to send requests and/or responses back to originators for clarification or to forward to others for technical assistance. The IMS may track each activity and enable users to determine their respective tasks requiring completion, etc.

Interface Agreements may include data such as Need Date, Accepted Date and Close Date. The Need Date documents the date the requesting party requires the information in order to complete or continue with their scope of work. The Need Date must be accepted by both parties to the agreement. The Accepted Date is the date that the responding party (party responsible for providing the requested information), agrees to the terms and conditions set forth in the Interface Agreement, including the required Need Date. The Close Date is the date the requesting party confirms that the response they have received is acceptable and closes out the Interface Agreement. These dates are important as they can be tracked to and compared with schedule activity id's and the dates tracked within the work schedule. The following comparison can be made:

| Work Schedule Field | Interface Agreement Field |
|---|---|
| Actual Start | Accepted Date |
| Planned Finish | Need Date |
| Actual Finish | Close Date |

User computers (e.g. 210 or 212) may have and/or provide access to project management applications such as a scheduling application (220A, 220B) having scheduling functionality for managing project schedules. In some examples, the scheduling applications used by a respective contractor scheduling manager such as for work in relation to a specific work package or packages. In some examples the scheduling application may be used by a PMC or EPCM scheduling manager to manage all work on a particular project which may relate to the work of many contractors. It will be appreciated that the scheduling applications 220A and 220B are shown in a simplified manner and that they may be provided via one or more servers (not shown) and be in communication with respective databases (not shown). It is understood that some of the users (e.g. Interface Managers) of application 216 may not be users of applications 220A and 220B and vice versa. For example, within an organization, one user may be responsible for interface management and have access to application 216 and another user such as a Planner may be responsible for scheduling management and have access to application 220A or 220B.

It is understood that the servers 202, 204, 206 comprise computer devices coupled for communication via one or more networks and that the server computer devices may comprise programmable processors and one or more data stores (e.g. memory or other storage devices/media) having instructions for configuring the execution of the processors to provide the features and functions. Thus the methods may be implemented in software. For scalability and robustness, commercial computing devices configured as dedicated servers may be used. The various user computers may also comprise similar computing devices though typically they will comprise computing devices (client machines) configured for individual users, such as laptops, tablets, desktops, workstations and smartphones. Persons of skill in the art will appreciate that other types of processing units, besides programmable processors, may include hardware based types such as application specific integrated circuits (ASICs) etc. Implementation of the hardware state machine so as to perform the functions and methods described herein will be apparent to persons skilled in the relevant art(s). In yet another embodiment, the methods are implemented using a combination of both hardware and software.

The various computing devices may comprise operating systems, communication sub-systems (e.g. wired and/or wireless based), user input and/or output devices such as keyboard, displays including touch screen displays, pointing devices, audio input, audio output, etc. The interface management application 216 may be configured as a browser based application. It is understood that other application configurations such as native applications for specific operating environments may be employed. User computers may be configured with browsers and other applications for example.

### Schedule Integration

In today's mega projects, implementing a collaborative interface management program is critical to achieving alignment between project stakeholders and to reduce interface-related project risk. Best practices have been established for the systematic identification of interface points and interface agreements, and the collaboration between contractors for the management of interfaces throughout the project lifecycle. Automated solutions such as Interface Management Solutions (IMS) (e.g. software and hardware) may be used to define interface points and interface agreements and work processes in the IMS may be used to monitor the execution of same. Project controls for interface management have matured such that a project owner and each of the major contractors involved in an integrated interface management program using a collaborative IMS can easily monitor scope, progress, quality and change requests.

To further alignment among the stakeholders and to collaborate in the achievement of the project while reducing risk, there is provided a systematic monitoring of schedule impact by all project stakeholders, which is presented herein as “Schedule Integration”. Each project stakeholder may be enabled to integrate high risk interface points, managed in the IMS, as milestone activities within a respective stakeholder's project schedule. Properly executed, this ensures that interface-related schedule risk can easily be identified by each contractor and the project owner, and that an efficient process exists to resolve interface-related schedule issues. This strategy also standardizes the project controls used to monitor unresolved interface-related schedule issues by Interface Managers and Project Planners at each stakeholder's organization.

The contracting strategy used by project owners of today's mega projects normally results in multiple work packages being awarded to multiple contractors that are geographically dispersed. This is executed with the objective of minimizing both technical and delivery risk to the overall project.

Interface management in mega projects starts with the identification of interface points early in the project life cycle, and identifying these project interfaces for each work package. These interface points may be physical, commercial or environmental in nature. Interface points can be internal to a work package, or external (existing between different contractors and work packages). External interface points normally represent higher risk to the project because of the increased coordination required to establish and execute the associated interface agreements. Therefore, external interface points should normally be tracked in a project schedule. Interface points and agreements are also defined, processed and monitored in an interface management solution such as application 216.

A master project schedule is managed by either the project owner, or typically by a PMC or EPCM firm representing the owner, who is experienced in managing mega projects with international contractors. Project schedules are typically maintained using software applications with scheduling functionality such as Primavera P6™ from Oracle Corporation. Despite significant advances in integrated project management practices, separate project schedules are almost always maintained by every contractor involved in the mega project. This practice increases the complexity of identifying the schedule impact of interface points, since schedule issues could arise in the master project schedule, or in any of the contractors involved with an interface point. Without a strategy that allows each stakeholder to easily integrate their interface points into their respective project schedule, and communicate interface-related schedule risk with other project stakeholders, substantial reduction in interface-related risk through schedule integration is difficult to achieve.

Interface management applications (such as application 216) and project scheduling applications (such as 220A or 220B) can be used together to significantly reduce interface-related project risk. In summary, application 216 may be used (e.g. by an Interface Manager) to compare interface agreement Need dates with activities and milestones in their work schedule. This comparison process involves exporting the work schedule of the project from the scheduling application 220A/220B, importing the schedule into application 216 configured with schedule integration, mapping data as may be necessary, and executing comparison functionality to determine risks such as scheduling discrepancies.

Project schedules in the scheduling application 220A/220B may be defined with interface point related information to provide a means for application 216 to link project schedule activities and interface activities. Scheduling application 220A/220B may provide the ability to add a user defined or custom field for the storage of an interface document number such as is used in application 216. Working with the Interface Manager, the Planner (e.g. user of scheduling application 220A/220B) updates the appropriate schedule activities (i.e. inputs in to the schedule data) with the relevant Interface Point or Interface Agreement document number. The data is then exported from the scheduling application 220A/220B. FIG. 3 shows a example of an exported activities schedule 302, such as may be exported to an Excel™ (from Microsoft Corp.) or other spreadsheet format. Other formats may be used. Schedule 302 includes data from a user defined field 302 in the schedule application having interface point or interface agreement document number references for the activities.

To support work schedules in various formats, application 216 may be configured to support a mapping file (e.g. an XML formatted mapping file) to define the structure of the data to be imported. Mapping files may be used to map the data being imported to the appropriate fields on a database table used by application 216. In one example, data fields include:
a. PlanStartDate
b. PlanFinishDate
c. ActualStartDate
d. ActualFinishDate.
e. ExternalID (Activity ID)
f. ExternalCode
g. Name (Activity Title)
h. InterfaceNumber<User defined field containing Interface Point or Interface Agreement document number>

Mapping files may include properties, for example, to assist with mapping processing:
a. HeaderRows—this property defines how many rows to skip when importing a file
b. SheetNamePattern—this property allows for different mapping files per worksheet
c. FileNamePattern—defines acceptable default file formats

FIG. 4 shows an excerpt 400 from an example XML-based mapping file for the data fields and properties described above. It will be apparent that definitions related to some of the data fields is omitted for brevity.

As is known, mapping files typically use data definitions in XML files, which are stored (not shown) on the application server 202 (see FIG. 2). If a field is added to the schedule (e.g. 300), which is desired to be imported and potentially reported against, a corresponding description for such field is then set forth in the data definition file. FIG. 5 shows an example 500 of an XML data definition file.

Application 216, in one example, supports a folder structure to handle multiple mapping and data definition files if it is required that unique formats be supported for each project. Properties defined on the project are used to determine the correct mapping and data definition files to be used.

Application 216, in one example, supports a Packages user interface to select a package and perform a schedule import of schedule data. Prior selection of a package ‘ties’ the schedule to the package for subsequent reporting. FIG. 6 shows a screen shot of a Packages user interface 600 including a listing of packages 601, showing package data such as short and long descriptions 602 and 604, phase 606, awarded contract party 608, issue start and completed dates 610 and 612. A control (e.g. 614) may be invoked to initiate the importation of a schedule for a particular package. Control 614 is associated to package CSC, for example. Control 614 is in the form of an icon such as a calendar page.

As each import is performed, a copy of the data definition and mapping file is stored in the database 204 along with the import job (e.g. Excel formatted schedule data).

Application 216 may be configured with a user interlace to support an import service, for example, a multi-threaded service that controls import jobs. A wizard like workflow can be provided to walk through the steps of importing a file, prompting for data etc.

The import service, upon execution, will read each row in the work schedule updating the appropriate schedule tables in the database 204. FIG. 7 shows an example object model 700 for schedule integration. Each import of a schedule 702 is associated with a project 704, a contracting party 706 and a work package (708). Multiple revisions of a work schedule 702 are supported, with the ability to query the database to access previous revisions—ScheduleRevision table 710. Each row in the work schedule (see FIG. 3) represents an Activity ID (imported schedule data field) from the schedule's work breakdown structure (WBS) and is stored in a combination of the WorkBreakdownStructure table 712 and ScheduleActivity table 714.

Each row in the work schedule has an associated Interface Document number from field 302. The import service feature of application 216 looks for an existing interface document 716 in database 204 that matches the given number/value of the imported field. The matched interface document 716 is then associated with the appropriate Activity ID in the WorkBreakdownStructure table 712. If an existing interface document number cannot be not found, the import service records an invalid association which can subsequently be reported on.

The ScheduleActivity table 714 contains a column (IsCriticalPath) to indicate whether the Activity ID is on the schedule's critical path. The critical path indicator can be used to highlight and report on interface documents that have been identified as on the critical path.

The following tables provided additional data description of the Schedule Database tables used for the importing of work schedules and for the execution of the Work Schedule Discrepancy and Exception reports (described below) and for the identification interface documents on the critical path.

### Database Tables

Schedule 702—Represents a contractors work schedule (and all revisions) for a project.

| Column Name | Description |
|---|---|
| schedule_id | Unique identifier |
| project_id | Associated project |
| contractingpartyrole_id | Associated contracting party |
| package_key | Associated work package |
| Name | Full name |
| Shortname | Short name |
| external_id | Unique identifier from another system |
| | (likely a GUID) |
| default_unit_of_measure | Unit of measure for time estimates |
| current_schedule_revision_id | The current revision of the schedule |
| last_update_number | Used to avoid “stale updates” |
| create_datetime | Create date/time |
| last_update_datetime | Last update date/time |

Schedule Revision 710—A single revision a schedule.

| Column Name | Description |
|---|---|
| schedule_revision_id | Unique identifier |
| creator_id | User that created the revision |
| create_datetime | Create date/time |
| last_update_number | Used to avoid “stale updates” |
| schedule_id | Parent schedule |
| Revision | Revision number (1, 2, 3, . . . ) |
| Revcode | Revision code (text) |
| Remarks | Arbitrary text |
| last_update_datetime | Last update date/time |

Work Breakdown Structure (WBS) 712—A node in the work breakdown structure. Nodes have a parent/child hierarchy.

| Column Name | Description |
|---|---|
| schedulewbs_id | Unique identifier |
| create_datetime | Create date/time |
| last_update_number | Used to avoid “stale updates” |
| last_update_datetime | Last update date/time |
| Name | Name of the wbs node |
| Description | Arbitrary text |
| Remarks | Arbitrary text |
| external_id | Unique identifier from another system (likely a |
| | GUID) |
| external_code | Human readable identifier for the wbs node |
| | (e.g. 5) |
| full_external_code | The fully qualifed external code is a |
| | combination of this item's code and its |
| | ancestors' codes (e.g. 1.8.5) |
| schedule_revision_id | Parent revision |
| parent_id | Parent can be a schedule revision or a |
| | schedule wbs |
| parent_type | Type of parent (revision or wbs) |
| original_start_date | Original start date |
| original_finish_date | Original finish date |
| plan_start_date | Planned start date |
| plan_finish_date | Planned finish date |
| forecast_start_date | Forecast start date |
| forecast_finish_date | Forecast finish date |
| actual_start_date | Actual start date |
| actual_finish_date | Actual finish date |
| unit_of_measure | Unit of measure for time estimates |
| cost_weight | The cost weight of this wbs compared to its |
| | siblings |

Schedule Activity 714—An extension of the WBS table above. Activities cannot have children.

| Column Name | Description |
|---|---|
| scheduleactivity_id | Unique identifier (joins to wbs table) |
| is_critical_path | Boolean value |
| actual_duration | Duration in hours |
| total_float_hours | Total float |
| plan_hours | Planned hours to completion |

Schedule WBS Association (e.g. to 716)—An entry in this table associates a WBS node (typically an activity level node) to any other business object (the target). This is a many-to-many relationship, allowing many target objects to be associated with the same WBS node.

| Column Name | Description |
|---|---|
| schedulewbsassociation_id | Unique identifier |
| last_update_number | Used to avoid “stale updates” |
| create_datetime | Create date/time |
| target_id | Associated IP or IA |
| target_type | Associated type of target |
| Entitykey | Human readable identifier for the target |
| schedulewbs_id | Associated wbs node |
| schedulewbs_type | Type of associated wbs node |

The IMS (e.g. application 216) provides a user interface to view all import jobs. The Import Register provides authorized users with a view of all imports which have been executed against the selected project. FIG. 8 is a screen shot of an example Import Register 800. The Import Register provides a history of previous imports. Authorized users can download data input files which have been previously loaded.

Because multiple parties (e.g. two or more contractor IMs) are usually involved with the management of each interface, application 216 is configured with the ability to track multiple Activity IDs to a given Interface Point or Interface Agreement. This ensures that each individual contractor can import their work schedule for comparison, as well as support the ability of the Owner/Operator (e.g. PMC or EPCM) to import a master work schedule if desired. In addition, users have the ability to locate an Interface Point or Interface Agreement using the associated schedule Activity ID from the IMS search.

Because work schedules differ from one project to another and the level of detail can vary from one contractor to another, application 216 configured with schedule integration allows the Interface Manager to compare dates at an interface point level or at the interface agreement level. When the Interface Manager tracks activities at the interface point level in the work schedule, application 216 configured with schedule integration compares the Planned Finish Date of the activity against the interface agreement Need Dates for the specified interface point. If the Need Date on any interface agreement created for the interface point falls outside the specified tolerance of the Planned Finish Date of the activity, the activity may be identified in a Work Schedule Discrepancy report. If activities in the work schedule are tracked at the interface agreement level, each activity is mapped to an interface agreement and application 216 can compare the Planned Finish Date of the activities to the interface agreement Need Date.

In summary, the process for comparing work schedules using application 216, can be summarized as follows:

1. Create user-defined field (as may be necessary if such field or alternative field does not exist) for receiving corresponding interface point or interface agreement numbers/values (e.g. linking data to the data stored in application 216) in the project work schedule.

2. Input the numbers/values (i.e. the linking data) for the interface points and interface agreements that the Interface Manager wants to associate with work schedule activities into the user-defined field.

3. Export the work schedule or a sub-set of the work schedule, including the user defined field/linking data, from the project scheduling system, for example, as an Excel file.

4. Update, if necessary, the default mapping file for the work schedule. After the first import, this step is only required if there is any change to the format of the work schedule.

5. Import the work schedule to the application 216 configured with schedule integration.

6. Identify project schedule issues. With a project and/or work schedule imported, a Work Schedule Discrepancy report is executed which will compare the activity ID Planned Finish date identified in the schedule, with the Need Dates identified and stored in the IMS for the related Interface Point and/or Interface Agreement. FIG. 9 is an example Work Schedule Discrepancy report 900. Based on the information provided, the Interface Manager evaluates options to avoid or mitigate the schedule impact of an interface point discrepancy with their project schedule. This starts by drilling down in the IMS to understand the specific interface agreements within the project that are impacted.

Assess impact to the critical path as part of the Project Planner's regular analysis of the critical path, any impact cause by an interface point, or impacting an interface point is identified, assessed and reported back to their Interface Manager. If the Work Schedule Discrepancy report identifies interface agreements which are related to interface points on the critical path, special attention must be given by the Interface Manager to mitigate against additional schedule impact of downstream activities. The ‘IsCritical’ path identifies on an interface point is an additional flag (attribute) of the interface point which can be used in reporting.

To assist in the schedule impact analysis, the Work Schedule Discrepancy report can be executed (FIG. 8). The report compares the Activity ID Planned Finish Date on the imported work schedule with the Need Date of the Interface Point and/or Interface Agreement that are included in the schedule. The report may be executed by selecting the appropriate work schedule (previously imported). A tolerance filter (802) may be applied and a value, typically expressed as a number of days (0 or more), input for the tolerance filter. Any document where the number of days between the compared dates is larger than the tolerance filters, is identified (e.g. 804) such as by using a different color or other different mode of presentation compared with the other dates on the report. In FIG. 8, the dates beyond the tolerance filter are in bold underline mode. The report may be configured to identify the following issues:
a. Unassigned Activity IDs, that is Activity IDs with no associated interface document 716;
b. Activity IDs that have been mapped to interface documents 714 that do not exist, that is the interface document 714 is invalid

In addition, a Work Schedule Exception report (not shown) identifies these documents:
a. Interface documents found with no Activity ID
b. Cancelled interface documents

The Interface Points and Interface Agreements stored in the IMS Interface Register (database) which are associated to an Activity ID by a work schedule import will automatically display the Activity ID on the form. That is, work schedule information imported from a work schedule is reflected on the IP and IA forms (user interface of the IMS)—if tied to a schedule Activity ID, the IP form will display a grid which lists all the Activity IDs to which it is associated. Application 216 supports mapping multiple Activity IDs to a single IP or IA.

### Value Proposition Scenarios

The following two scenarios represent typical interfaces in an industrial mega project. Both demonstrate the positive impact of collaboration on interfaces between contractors, as well as the value of integrating high risk interface points with each stakeholder's project schedule.

In a first scenario during a design phase, the delay in completion of a key interface agreement impacts a critical path activity for another contractor. An Interface Breakdown Structure (IBS) is a manner of or approach to considering and/or representing interface information (e.g. data representing interface points and agreements, etc.) stored in the IMS. One approach may start with an IP, then group by Phase and then each individual Interface Agreement by Phase. Another approach might be to start at a Package level, then down to IP and then to Interface Agreements Table 1 shows an example IBS:

TABLE 1
Interface Breakdown Structure for a First Scenario

| | Level 2 | Level 3 (Interface |
|---|---|---|
| Level 1 (Interface Point) | (Phase) | Agreement) |
| An interface point is being | Design | A key interface agreement |
| managed for a terminating | | is created for Contractor A |
| pipe that spans two scope | | to confirm their |
| packages. Two contractors | | specifications for the high |
| are involved - one for each | | pressure titanium piping |
| scope package the pipe | | material for Contractor B. |
| spans. | | |

In this scenario the interface agreement need date is agreed upon early in the design phase. This interface agreement need date is the latest in the phase, and equals the interface point's design phase forecasted finish date. Contractor A does not complete the interface agreement by the need date. Contractor B's Interface Manager is automatically notified from the IMS. After importing the weekly schedule, the Interface Manager for Contractor B, has identified the schedule slippage on the interface point, which is on the critical path, for the design phase. The Interface Manager quickly identifies the schedule variance, and that it will impact a dependent interface agreement—the procurement of the long lead time titanium. Without the detailed specifications, the procurement of the titanium piping must be put on hold.

Without integration of the interface point into Contractor B's project schedule, and identification of the dependencies for the interface point, the interface manager may never have been aware of the schedule impact of this subtle, but critical interface agreement to confirm piping specifications. Contractor B's Interface Manager works with the contractors Planner and notifies procurement of the schedule impact on procurement of the long lead time titanium. Working together, they discuss how to expedite completion of the interface point with Contractor A.

In a second scenario, during commissioning phase, the delay in material delivery for Contractor A results in a delay of an interface point that impacts Contractor B. Table 2 shows an example Interface Breakdown Structure.

TABLE 2
Interface Breakdown Structure for a Second Scenario

| | Level 2 | Level 3 (Interface |
|---|---|---|
| Level 1 (Interface Point) | (Phase) | Agreement) |
| An interface point is being | Commissioning | Several interface |
| managed for testing of a | | agreements are created |
| flanged joint on piping | | for the commissioning |
| between two scope packages. | | phase, including one |
| Two contractors are | | where Contractor A and |
| involved - one for each | | Contractor B agree upon |
| scope package the pipe spans. | | the need date and details |
| | | of how each contractor |
| | | will complete commis- |
| | | sioning tightness testing |
| | | for the flanged joint. |

In this second scenario, both Contractor A and Contractor B have flagged this interface point for commissioning phase as high risk in the IMS. The Interface Manager's at both contractors have worked with their project planner and added this as a milestone to their organization's project schedule.

Late in the construction phase, Contractor A experiences a delay in delivery of required piping material, meaning the piping installation will be delayed. The interface agreement detailing the piping installation is updated to reflect the delay. After importing the weekly schedule, the Interface Manager identifies that the interface agreement Need Date is outside the boundaries of the acceptable tolerance. Working with the planner, the Activity ID Planned Finish Date of the piping installation activity is updated. The project planner's schedule variance reports identify that this delay will impact the interface point milestone and future commissioning testing. Contractor As project planner notifies their Interface Manager of this issue. Contractor As Interface Manager investigates this interface point, and identifies the specific interface agreement that will be impacted. Contractor As Interface Manager initiates a change request in the IMS, requesting the change to the need, and includes details of the procurement delay that is driving the change request. Contractor B's Interface Manager reviews the change request and approves. The interface agreement's need is updated. The need date is subsequently updated on the Interface Agreement.

Without integration of the IMS and the contractor's project schedule, Contractor A may not have even been aware of the impact on the Interface Agreement in time to initiate a change request and disclose the schedule issue to all impacted parties.

It will be appreciated by those of ordinary skill in the art that the matter can be embodied in other specific forms without departing from the spirit of essential character thereon.

What is claimed is:

1. A computer implemented method of collaborative interface management comprising:
maintaining interface information in a database for a plurality of interfaces associated with a project, each interface having a need date of completion;
receiving at a processing unit work schedule information comprising respective work activities each activity having a planned finish date and an interface identifier for associating the work activity with a particular interface;
storing in the database by the processing unit the work schedule information in association with the interface information; and
analyzing by the processing unit the work schedule information and interface information to determine schedule discrepancies.

2. The method of claim 1 comprising providing by the processing unit a user interface for defining the interface information, the interface responsive to workflow for collaboratively managing the processing of the interface information by a plurality of users and receiving by the processing unit input to process the interface information, the input generated in response to at least one schedule discrepancy.

3. The method of claim 2 wherein the plurality of users are one or more contractor interface managers and one or more owner/operator interface managers having responsibilities to collaboratively manage the completion of the project.

4. The method of claim 1 further comprising providing by the processing unit an interface for importing the work schedule information, the work schedule information comprising output from a scheduling application.

5. The method of claim 4 comprising mapping by the processing unit the work schedule information in accordance with a data definition for storing the work schedule information.

6. The method of claim 4 wherein the interface identifier is defined by inputting the interface identifier into the scheduling application to link a work schedule activity with an interface.

7. The method of claim 6 wherein the interface identifier is input into a user defined field provided by the scheduling application.

8. The method of claim 1 wherein some of the interface information for a particular interface defines an interface point related to one or more work packages awarded to respective contractors for completion in a construction project and wherein the interface identifier is used to associate at least one activity of the work schedule to a particular interface point.

9. The method of claim 1 wherein some of the interface information for a particular interface defines an interface agreement for at least one contractor to perform work to complete the particular interface in a construction project and wherein the interface identifier is used to associate at least one activity of the work schedule to a particular interface agreement.

10. The method of claim 1 comprising comparing by the processing unit the respective need date and planned finish date to determine the schedule discrepancies.

11. The method of claim 10, wherein the comparing is responsive to a user defined tolerance.

12. The method of claim 1 wherein the work schedule information comprises data identifying at least some of the activities as critical, the method further comprising identifying interfaces associated the critical activities as critical.

13. A system for collaborative interface management comprising a processing unit and a database, the processing unit configured to:
maintain interface information in the database for a plurality of interfaces associated with a project, each interface having a need date of completion;
receive work schedule information comprising respective work activities each activity having a planned finish date and an interface identifier for associating the work activity with a particular interface;
store in the database the work schedule information in association with the interface information; and
analyze the work schedule information and interface information to determine schedule discrepancies.

14. The system of claim 13 wherein the processing unit is configured to: provide a user interface for defining the interface information, the interface responsive to workflow for collaboratively managing the processing of the interface information by a plurality of users; and receive input via the user interface to process the interface information, the input generated in response to at least one schedule discrepancy.

15. The system of claim 14 wherein the plurality of users are one or more contractor interface managers and one or more owner/operator interface managers having responsibilities to collaboratively manage the completion of the project.

16. The system of claim 13 wherein the processing unit is configured to provide an interface for importing the work schedule information, the work schedule information comprising output from a scheduling application.

17. The system of claim 16 wherein the processing unit is configured to map the work schedule information in accordance with a data definition for storing the work schedule information.

18. The system of claim 16 wherein the interface identifier is defined by inputting the interface identifier into the scheduling application to link a work schedule activity with an interface.

19. The system of claim 18 wherein the interface identifier is input into a user defined field provided by the scheduling application.

20. The system of claim 13 wherein some of the interface information for a particular interface defines an interface point related to one or more work packages awarded to respective contractors for completion in a construction project and wherein the interface identifier is used to associate at least one activity of the work schedule to a particular interface point.

21. The system of claim 13 wherein some of the interface information for a particular interface defines an interface agreement for at least one contractor to perform work to complete the particular interface in a construction project and wherein the interface identifier is used to associate at least one activity of the work schedule to a particular interface agreement.

22. The system of claim 13 wherein the processing unit is configured to compare the respective dates and need dates to determine the schedule discrepancies.

23. The system of claim 22, wherein the comparing is responsive to a user defined tolerance.

24. The system of claim 13 wherein the work schedule information comprises data identifying at least some of the activities as critical and wherein the processing unit is configured to identify interfaces associated with the critical activities as critical.

25. A computer program product comprising a non-transitory medium storing instructions and data for configuring the execution of a processing unit to provide collaborative interface management, the processing unit configured to:
maintain interface information in the database for a plurality of interfaces associated with a project, each interface having a need date of completion;
receive work schedule information comprising respective work activities each activity having a planned finish date and an interface identifier for associating the work activity with a particular interface;
store in the database the work schedule information in association with the interface information; and
analyze the work schedule information and interface information to determine schedule discrepancies.
